(19) United States
(12) Patent Application Publication
(10) Pub. No.: US 2014/0279097 A1
(43) Pub. Date: Sep. 18, 2014

(54) Purchasing Method with Funding Source Selection

(71) Applicant: MOBIbucks Corporation, Sunnyvale, CA (US)

(72) Inventors: Ziad Alshobaki, Dubai (AE); Jorge M. Fernandes, Los Altos, CA (US)

(73) Assignee: MOBIbucks Corp., Sunnyvale, CA (US)

(21) Appl. No.: 13/937,076

(22) Filed: Jul. 8, 2013

Related U.S. Application Data
(60) Provisional application No. 61/782,593, filed on Mar. 14, 2013.

(51) Int. Cl. G06Q 20/10; G06Q 20/32; G06Q 20/20

(52) U.S. Cl. CPC G06Q 20/10; G06Q 20/20; G06Q 20/327
USPC 705/16

(57) ABSTRACT

A process includes receiving a message containing an a priori funding source selection for a payment service used to conduct a purchase transaction that is sent via SMS from a purchaser. The process also includes receiving a request to transfer funds to the merchant on behalf of the purchaser that is sent from a device associated with a merchant. The process also includes completing the purchase transaction. The funds transferred to the merchant on behalf of the purchaser are taken from a funding source selected by the a priori funding source selection. The a priori funding source selection is stored so as to apply to all future transactions conducted by the purchaser using the payment service until the server device receives a second a priori funding source selection from the purchaser.

### CROSS-REFERENCE TO RELATED APPLICATIONS

This application claims the benefit of U.S. Provisional Application No. 61/782,593, filed Mar. 14, 2013, which is incorporated herein by reference in its entirety.

### BACKGROUND OF THE INVENTION

When purchasing an item or service from a merchant, a customer typically has several options available for affecting their purchase. The customer, or purchaser, can pay with cash, a check, or choose from a number of credit or debit cards. The purchaser may also choose to make a partial payment for the total value of the purchase by using a gift card or coupon. In the case of an in-store purchase, the chosen option is physically handed to the merchant to process the purchase transaction using a point of sale terminal. The merchant may decide beforehand, or a priori, to disallow some forms of payment. For example, the merchant may not allow checks or may only accept certain credit cards.

Methods relating to the subject matter of the following disclosure allow a purchaser to choose a payment method electronically. These systems require a purchaser to select their payment method at the time of the transaction based on what methods of payment are acceptable to a given merchant. More user friendly interfaces for selecting a payment method are provided by sophisticated electronic devices. As a result, electronically available payment methods have mainly been made accessible via intelligent mobile interfaces on smart phones or web applications on a personal computers or sophisticated tablets. For example, certain electronic wallet applications have been made available for smart phones that allow a purchaser to select a particular funding option for a transaction using an application with multiple windows and menu options. As another example, purchasers have been able to store different funding sources with a particular online merchant using a web interface on a personal computer.

### BRIEF SUMMARY OF THE INVENTION

In one embodiment of the invention a process for conducting a purchase transaction is provided. The process includes storing a first prioritize set of funding sources received from a purchaser in a database. The process also includes storing a second prioritized set of funding sources received from a merchant in the database. The process also includes receiving a message containing information that identifies the purchaser from a point of sale terminal associated with the merchant. The process also includes receiving a message containing a transaction amount for the purchase transaction from the point of sale terminal associated with the merchant. The process also includes selecting a funding source to affect the purchase transaction based on the first and the second prioritized list. The process also includes conducting a transfer of funds from the funding source to affect the purchase transaction using a server in communication with a back end payment processing system. The first and second prioritized sets of funding sources are stored in the database prior to the step of receiving the message containing information that identifies the purchaser. The server retrieves the first and second prioritized sets of funding sources from the database to select the funding source for the purchase transaction.

In another embodiment of the invention a computer-implemented method for performing a purchasing transaction between a purchaser and a merchant is provided. The process includes receiving a request to purchase an item or service from the merchant comprising information about an item or service at a server device from a device associated with the merchant. The method also includes receiving information identifying the purchaser at a server device from the device associated with the merchant. The method also includes sending a funding source selection from a list of funding source options associated with the purchaser to the device associated with the merchant from the server device. The method also includes completing a purchase transaction where the funds used to purchase the item or service are taken from the funding source selected. The step of sending a funding source selection comprises selecting a funding source based on data associated with the purchaser or data associated with a history of purchases by the purchaser at the merchant. The list of funding source options associated with the purchaser are configured a priori by the purchaser using a message sent to the server device via SMS.

In another embodiment of the invention a process is provided. The process includes receiving a message contains an a priori funding source selection for a payment service used to conduct a purchase transaction that was sent via SMS from a purchaser. The process also includes receiving a request to transfer funds to the merchant on behalf of the purchaser at a server device from a device associated with a merchant. The process also includes completing the purchase transaction. The funds transferred to the merchant on behalf of the purchaser are taken from a funding source selected by the a priori funding source selection. The a priori funding source selection is stored so as to apply to all future transactions conducted by the purchaser using the payment service until the server device receives a second a priori funding source selection from the purchaser.

As used in this summary, the remainder of this disclosure, and in the amended claims; the term “prioritized set” references a group of at least two elements wherein each element is treated preferentially over another in the group. This preferential treatment is not static, as one element may be preferred over another in one situation to which the set is applied, while the two elements are treated with reversed preference in another situation to which the set is applied.

### BRIEF DESCRIPTION OF THE DRAWINGS

FIG. 1 is a block diagram of a point-of-sale purchasing system according to an embodiment of the present invention.

FIG. 2 is a flowchart of a purchasing method involving the storage of a set of funding options that is in accordance with embodiments of the present invention.

FIG. 3 is a flowchart of a purchasing method with merchant-side prioritization that is in accordance with embodiments of the present invention.

FIG. 4 is a flowchart of a purchasing method including a confirmation option that is in accordance with embodiments of the present invention.

FIG. 5 is a block diagram of an on-line purchasing system according to an embodiment of the present invention.

### DETAILED DESCRIPTION OF THE INVENTION

The present disclosure relates to methods of making purchases. In particular, the present disclosure relates to purchasing items or services wherein the method of payment is chosen a priori by a purchaser before a transaction begins. In the following description, for purposes of explanation, numerous examples and specific details are set forth in order to provide a thorough understanding of the present disclosure. It will be evident, however, to one skilled in the art, that the present disclosure as defined by the claims may include some or all of the features in these examples alone or in combination with other features described below, and may further include modifications and equivalents of the features and concepts described herein.

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. A second step is required to follow a first step only when the first step must be completed before the second step is begun. Such a situation will be specifically pointed out when not clear from the context. A particular step may be omitted; a particular step is required only when its omission would materially impact another step.

In this document, various computer-implemented methods, processes and procedures are described. It is to be understood that the various actions (receiving, storing, sending, communicating, displaying, etc.) are performed by hardware, even if the action may be authorized, initiated or triggered by a user, or even if the hardware is controlled by a computer program, software, firmware, etc. Further, it is to be understood that the hardware is operating on data, even if the data may represent concepts or real-world objects, thus the explicit labeling as “data” as such is omitted. For example, when the hardware device is described as “storing a record”, it is to be understood that the hardware device is storing data that represents the record.

Embodiments of the present invention allow electronic purchases to be made without sophisticated user interfaces, without excessive back-and-forth communications at a point-of-sale (POS) terminal, and without specialized code installed at the POS terminal. In certain approaches described below, a funding source for a transaction is selected automatically based on data provided a priori by both the purchaser and merchant before the transaction begins. These approaches exhibit certain advantages for merchants because they do not require specialized devices or software at the POS, and allows merchant to prioritize their choice of payment method. As a result, the merchant may pay lower fees with some credit cards, and thus be able to charge a lower purchase price if desired. In addition, a purchaser may avoid carrying various physical payment methods such as disparate credit cards, gift cards, or coupons. In certain approaches described below, a funding source for a transaction can be configured via an SMS message sent by a potential purchaser. This may be desirable as it provides the benefits of a configurable payment service to a wider array of potential users. Although the market penetration of smart phones and personal computers is substantial, both markets are minimal when compared to the penetration of basic handsets with more limited interfaces. In addition, SMS messaging used in accordance with certain embodiments disclosed below provide a streamlined method for configuring a purchaser's account prior to conducting a transaction which makes both payment selection and the actual purchase transaction more convenient.

Embodiments of the present invention allow for a convenient a priori choice of funding sources for a purchase. Prior to making a purchase, the purchaser sets up a database on a server with funding sources (e.g., credit cards, debit cards, gift cards, coupons, and the like), and, optionally, will give permission for the choice of a funding source for later purchases to be made automatically. At the time of a purchase, the choice of funding source is made automatically, based on criteria set up by the merchant. The criteria set up by the merchant could include a prioritized set of funding sources that the merchant will accept in a similar format to the choice of funding source that set up by the purchaser. The purchaser may have some input into the criteria used for the selection of funding source. Optionally, the purchaser may confirm or deny the selected funding source. If the funding source is confirmed, the purchase transaction will proceed and be completed using the selected funding source.

FIG. 1 shows a block diagram 105 of a system for facilitating a payment transaction. A merchant 140 and a purchaser 110 communicate with a device associated with the merchant 150. The merchant device 150 may be a POS terminal and may include a keypad entry device and may also include a card swiping mechanism. A POS terminal may also include two separate physical devices—one of which is predominately used to display information to the merchant and one of which is predominately used to display information to the purchaser. The merchant device 150 has access to an external server 130 via a network 120. This access may be via any communication means. The network 120 could be, for example, the Internet, or it could be a local area network or a proprietary long distance network. The external server maintains a database 135. The database 135 contains, for example, information about funding sources provided by the purchaser. The database 135 may also contain information about which merchants the purchaser has allowed to choose a funding source. The purchaser may have limited the funding sources that a given merchant may choose from; this information is also stored in the database. The database may also contain the information necessary to access the funding sources, so that merchant device 150 may facilitate the completion of the purchase transaction.

FIG. 2 shows a flowchart 200 of a transaction process. In step 201 a message is received from a purchaser. The message includes an a priori funding source selection for a payment service. Funding sources may include, but are not limited to, various credit cards, debit cards, direct transfer from bank accounts, gift cards, discount coupons, Internet-centric stored value accounts and the like. The message can beneficially be sent via SMS such that the purchaser does not need access to expensive electronic computing devices, but instead can send their funding source selection via an inexpensive handset with limited functionality. The funding source selection may be stored in a database associated with the payment service. For example, the funding source selection could be stored in database 135. The funding source selection could then apply to all transactions conducted by the purchaser in the future until another funding source selection was received from the purchaser. Method 200 could then continue to step 202 in which a request to transfer funds to a merchant on behalf of the purchaser is received by a server associated with the payment system. The server could be server 130. The message could be sent from a device associated with the merchant such as a point of sale terminal. The device associated with the merchant could have any of the characteristics of merchant device 150. Method 200 could then conclude with step 203 in which the transaction is completed. Step 203 could involve transferring funds to the merchant on behalf of the purchaser and taking those funds from the funding source selected by the purchaser in step 201.

The server that receives the request to transfer funds could be similar to the MOBI account server, described in U.S. Patent Publication No. 2009/0024533 A1 for “Payment Systems and Methods” filed Aug. 29, 2007, or U.S. patent application Ser. No. 13/755,421 for “Self-authenticating peer-to-peer transaction” filed Jan. 31, 2013, both of which are owned by the assignee of the present invention, and both are incorporated by reference herein in their entirety. Such a server may maintain a database containing, for example, personal identification information, for example, mobile phone numbers. The database would associate this identification information with other information; for example, funding sources, financial account information, and the like.

Method 200 and could include step 205 in which information is received by the server that identifies the purchaser. The information could be a mobile telephone number of the user. As mentioned previously, merchant device 150 can be a point of sale terminal and the purchaser can communicate with the payment service via a communication channel that includes an SMS message system. However, the purchaser, or the merchant, or both, may communicate with the payment service's servers via any means; for example, sending a text message or making a phone call with a mobile device, or through a smart phone application, or through a web site on a stationary device.

The purchaser may prioritize their funding source selections. Referring back to FIG. 2, the message received in step 201 by the payment service could include a set of prioritized funding sources. The prioritized set could be two or more funding sources that are prioritized such that the most highly ranked funding source that can be used for a transaction is used for that transaction. The prioritized set could also be two or more funding source that are prioritized for specific situations. For example, funding source A could be the most highly ranked funding source used if a purchase is made at a gas station while funding source B could be the most highly ranked funding source used if a purchase is made at a restaurant. As another example, funding source A could be the most highly ranked funding source if the purchase transaction has a price exceeding $100 dollars while funding source B could be the most highly ranked funding source of the purchase transaction has a price below $100 dollars. Finally, as another example, funding source A could be a coupon or gift card that is specific to a particular merchant such that it is the highest ranked funding source for a transaction conducted with that merchant, while funding source B could be a preferred funding source for transactions with any other merchant.

Method 200 could include step 204 in which a second funding source selection method is received by the payment service such as by server 130. The second funding source selection message could add another funding source to the set of prioritized funding sources. For example, the last funding source added could be set as the lowest ranked funding source in the prioritized set. As another example, the last funding source added could be set as the highest ranked funding source in the prioritized set. The second funding source message could also reconfigure the already identified funding sources in the set of prioritized funding sources. In situations where the messages were being sent via a communications channel that included an SMS system, it could be beneficial to allow the prioritized set to be configured using multiple messages so that the content of each message could be kept simple.

Multiple funding sources from within the set of funding source selections could be applied to affect payment for a single payment transaction. Funding sources from among these multiple funding sources may be exhausted during that single payment transaction. For example, a purchaser may not have enough money in their checking account to pay for an item and may have their checking account prioritized above one of their credit cards. In this example, all of the funds in the checking account could be withdrawn to affect payment for the transaction and then the remaining balance of the transaction could be covered by the purchaser's credit card. This type of payment flow could be conducted using a recursive request to a highly ranked funding source such that the request would continuously request a smaller and smaller portion of the overall purchase price until the request for funds was approved at which point the balance of the overall purchase price would be pulled from the next highest ranked funding source. Not all of the funds in a funding source need to be withdrawn or extracted from that funding source before the payment service would begin to draw funds from the next acceptable funding source. The purchaser may be able to set minimum amounts that must be left available in a funding source; and may likewise set maximum amounts that can be taken from a particular funding source before moving on to the next highest ranked funding source.

FIG. 3 illustrates a flow chart of a method 300. Method 300 illustrates a purchase transaction in which both the purchaser and the merchant are able to set a prioritized set of funding sources prior to the purchaser transaction. Method 300 begins with steps 301 and 302 in which a first and second prioritized set of funding sources are received from the purchaser and merchant and stored in a database. The sets can be received via any of the communications means discussed above and the database can have the characteristics of database 135. Steps 301 and 302 are drawn in parallel because there is no temporal restriction on which step happens first, but both sets must be received before step 303. In step 303, a message is received from a point of sale terminal that identifies the purchaser. Note that this step also inherently identifies the merchant because the merchant is associated with the point of sale terminal from which the message originated. The information that identifies the purchaser can be any of the kinds of information mentioned above; and, in particular, may be a mobile phone number of the purchaser. In step 304, a message is received from the point of sale terminal that contains a transaction amount for the purchase transaction. Note that although these steps are drawn separately, it is possible for both messages to be sent in a single transmission from the point of sale terminal (i.e., both the information identifying the purchaser and the transaction amount may be sent in the same message). The messages could be received by a server that may have the characteristics of server 130.

A funding source is then selected to affect the purchase transaction in step 305. The funding source can be selected based on the lists received in steps 301 in 302, and the selection process can be conducted in various ways. The prioritized sets of funding source can be retrieved from a database and operated on by the payment system server to select the funding source for the transaction. Since both parties have provided a list of funding sources they prefer, method 300 is able to provide advantages to both the merchant and the purchaser. Even if either party to the transaction is not able to use their most preferred funding source, it is likely that the overall utility of the transaction will be increased because the preferences of both parties have been taken into account. As a basic example, the most highly ranked funding source in either list is selected based on whether or not it appears anywhere in the other party's list. As another example, the payment service may rank every funding source in both lists by summing the rank value of each of those funding sources and dividing by two. This resulting average rank would then be used to select a funding source for funding the transaction by selecting the funding source with the highest average rank. The payment service may also allow purchasers or merchants to provide weights to the various funding sources that would be taken into account when calculating a combined rank based on both the purchaser's and merchant's preferred payment method. These weights could then be taken into account when determining which funding source to use such that a more heavily weighted funding source would be more likely to be selected. The transaction would then be conducted in step 306 through a transfer of funds affected by a server in communication with a back end payment processing system. The server could have the characteristics of server 135.

The method described with reference to FIG. 3 can be used in combination with any of the approaches described above with reference to FIG. 2. In particular, the purchaser could enter in a third prioritized set of funding source such that the first or third prioritized funding sources associated to the user would be used in step 305 based on the identity of the merchant. In other words, the purchaser could enter in various sets of prioritized funding sources based on the identity of the merchant. For example, a credit card that awarded points for specific kinds of transactions could be a prioritized funding source in one prioritized set that was meant to be applied to conduct those kinds of transactions. The merchant could likewise specify different prioritized sets of funding sources to be applied based on the identity of the purchaser, the item or service being provided in the purchase transaction, or any other temporal or situational detail regarding the transaction.

FIG. 4 shows a flowchart of a method 400. Method 400 is a purchase transaction. In step 410, a server such as server 130 receives a request to make a purchase. The request could be sent by the merchant, using, for example, a cash register key, or the request could be sent by the purchaser, using, for example, a key on a POS device, or by swiping a card. The card may be, for example, a card associated with any of the purchaser's funding sources. The request received in step 410 may also include information about the item or service being purchased; for example, the purchase price. The merchant or the purchaser may input this item or service information. The purchaser then inputs identity verification information to the merchant's POS device in step 415. This step could comprise, for example, entering the purchaser's mobile telephone number, or a personal identification number (PIN) specially assigned to the purchaser, or the PIN associated with one of the purchaser's funding sources, or some other form of identity verification. Alternatively, the purchaser's identity information may come from a card swipe, and it may comprise a credit or debit card number, for example. Regardless of how the identify information is obtained, it is used in step 425 to look up the list of the purchaser's funding sources in a database. The database could be database 135 which could be located on server 130.

In step 430 of FIG. 4, the funding source is selected automatically from among the funding sources retrieved from the database. Various methods can be applied for selecting the funding source from the purchaser's list of funding source. The funding source could be selected based on data associated with the purchase of a history of purchases made by the purchaser with the particular merchant involved in the transaction. The list of the purchaser's funding source could be compared to a list of funding sources that are allowed by the merchant and any funding source on that list that is allowed by the merchant could be used to complete the purchase transaction. If the list were a prioritized list, the highest ranked funding source allowed by the merchant could be selected to affect payment for the transaction. The list of the purchaser's funding source could also be compared to a list of funding sources as prioritized by the merchant. In those situations, various methods could be applied for selecting the proper funding source for completing the purchase transaction. For example, the funding source selected could be the highest ranked funding source in the merchant's list of prioritized funding source that is also in the purchaser's list. As another example, the funding source could be selected by taking the average ranking of each funding source appearing in both the purchaser's list and the merchant's list and selecting the funding source with the highest average ranking between the two lists. The method of selection could be as simple as: the merchant only allows a single funding source from this specific purchaser.

In the case where the funding source choice is determined by data associated with the purchase, a look-up-table such as that shown in Table A below could be used:

TABLE A

| Total Price of items or services | Funding source used |
|---|---|
| Less than $50 | Source A |
| $50 to $200 | Source B |
| $200 to $1000 | Source C |
| Greater than $1000 | Source D |

In this case, the data associated with the purchase used to select a funding source for the transaction is the purchase price. Other purchase data that could be used as criteria for funding source selection include the purchase type (service, item, etc.), the time of day or the day of the week, the number of items, or other criteria, as well as combinations of these criteria. Although this example shows a single prioritized funding source for each potential range of the purchase price, it is also possible for multiple funding sources to be prioritized for each potential range. This particular approach would be beneficial in situations where certain funding sources were not allowed by potential merchants for the purchaser's transactions or where the payment service offered merchants the option to specify their prioritized funding sources as was discussed with references to FIG. 3.

In the case where the funding source choice is determined by on a history of purchases made by the purchaser at the merchant, various factors can be taken into account. For example, if the purchaser had established a sufficient relationship with the merchant through repeat business and/or with transactions that exceed a certain size, the merchant might be able to specify that certain less reliable funding sources may be used by purchaser. As another example, a purchaser history of the user may be used to select a coupon or discount that is specific to the user to be applied to the purchase transactions. The discount or coupon could be based on the purchaser buying a certain quantity of a particular item, or could be awarded based on a total amount of money spent by the purchaser in transactions with the merchant.

In step 440 of FIG. 4, the merchant's POS device optionally requests the purchaser to confirm the choice of payment. In optional step 445, the purchaser either confirms or denies the choice of funding source made; for example, by pressing a “YES” or “ENTER” key on the POS device. This choice is checked in step 450, and, if the purchaser has confirmed the choice, the purchase transaction is completed in step 455. In step 455, for example, the server device may contact an agency that administers the funding source (such as a credit card company's server) to transfer funds from an account administered by the agency and associated with the purchaser to an account associated with the merchant. If instead the purchaser denies the selected funding source at the POS, the server may choose another source; for example, the lookup table method may be used with the chosen funding source removed and replaced with the funding source associated with the next highest purchase price.

The purchaser, possibly in combination with the merchant, may set up the database 135 a priori. The purchaser may input a list of funding sources, for example, using a web site form, or by filling out a physical form and mailing it. The purchaser may also input a list of merchants who are able to use this service. The purchaser may allow a different set of funding sources for each merchant. The purchaser may also submit identification information, for example, a mobile phone number, which the server may use to verify the purchaser's identity during later transactions. The external server 130 would ultimately receive this information (funding sources, merchants included, and identity data), and store it in the database 135. The server may then issue a compact identity code to the purchaser, for example, a secure personal identification number, or secure PIN, to be used during later transactions. The server may send this PIN to the purchaser, for example, in an e-mail, or via a postal service.

For merchants who maintain a database on-site (connected to the POS device via a LAN, for example), server 130 may download the database (or changes in the database) periodically to merchant's network, for example, hourly, or daily, or weekly. If the POS device is not connected to an open or external network, the database can be updated physically, for example, using a memory device via a Universal Serial Bus (USB) or Secure Digital (SD) port or slot on a computer connected to the POS device via a LAN.

Embodiments of the present invention include on-line purchase transactions as well as POS transactions. FIG. 5 shows a block diagram 500 of such an online transaction system. In this case, the purchaser 110 makes an online purchase from the merchant 140 through, for example, the merchant's web site. The purchaser 110 may access the merchant's web site on a stationary or mobile device, connected to a network 120, for example, the Internet. Both the purchaser 110 and the merchant 140 may transmit transaction information to the account server 130 via the Internet. For example, after the purchaser 110 indicates a desire to purchase an item or service via the merchant's web site, the purchaser may then be prompted by the web site to enter her mobile phone number and secure PIN. Once this information is verified, the server accesses the database 135 and extracts the purchaser's funding source options. The server will select the funding source, using the methods describe above. This choice is optionally verified by the purchaser, at which point the server 130 will process the purchase transaction.

The above description illustrates various embodiments along with examples of how aspects of the present invention may be implemented. For example, direct communication, U.S. mail, phone calls, text messages, data messages or e-mail through wired or wireless voice or data channels, encrypted or not encrypted, and the like may all be considered communication means for sending any messages required by the system. A mobile device may be a mobile phone, two-way pager, tablet or notebook computer, and the like. A compact identity code may be a PIN, or a pseudorandom code, or the like.

The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A process for conducting a purchase transaction comprising:
storing in a database, a first prioritize set of funding sources received from a purchaser;
storing in said database, a second prioritized set of funding sources received from a merchant;
receiving, from a point of sale terminal associated with said merchant, a message containing information that identifies said purchaser;
receiving, from said point of sale terminal associated with said merchant, a message containing a transaction amount for said purchase transaction;
selecting a funding source to affect said purchase transaction based on said first and said second prioritized list; and
conducting a transfer of funds from said funding source to affect said purchase transaction using a server in communication with a back end payment processing system;
wherein:
said first and second prioritized sets of funding sources are stored in said database prior to said step of receiving said message containing information that identifies said purchaser; and
said server retrieves said first and second prioritized sets of funding sources from said database to select said funding source for said purchase transaction.

2. The process of claim 1, wherein said transfer of funds comprises:
conducting a transfer of a balance of funds available from a first funding source in said first prioritized set of funding sources using said server; and
conducting a transfer of funds from a second funding source in said first prioritized set of funding sources using said server;
wherein said amount of funds transferred from said second funding source is equal to a total purchase price of said purchase transaction less said balance of funds available from said first funding source.

3. The process of claim 1, further comprising:
storing a third prioritize set of funding sources received from a purchaser in said database;
wherein either said first or said third prioritized set of funding sources is applied by said server to conduct said transfer of funds based on an identity of said merchant.

4. The process of claim 1, wherein
said server selects said funding source for said transfer of funds based on a purchase price of said purchase transaction.

5. The process of claim 4, wherein
said second prioritized set of funding sources includes a single prioritized funding source for each potential range of said purchase price.

6. The process of claim 1, wherein
said first prioritized set of funding sources is received from said purchaser via a communications channel that includes an SMS messaging system.

7. The process of claim 6, wherein
said message containing information that identifies said purchaser identifies said purchaser by a mobile phone number.

8. The process of claim 7, further comprising:
sending, to said point of sale terminal from said server, a request to confirm said purchase transaction;
receiving, at said server from said point of sale terminal, a response to said request to confirm said purchase; and
completing said purchase transaction if said response indicates that said purchaser has confirmed said purchase;
wherein said request to confirm said purchase transaction identifies said funding source for said transfer of funds.

9. A computer-implemented method for performing a purchasing transaction between a purchaser and a merchant, the method comprising:
receiving, at a server device from a device associated with the merchant, a request to purchase an item or service from the merchant, the request comprising information about the item or service;
receiving, at the server device from the device associated with the merchant, information identifying the purchaser;
sending, to the device associated with the merchant from the server device, a funding source selection from a list of funding source options associated with the purchaser; and
completing the purchasing transaction, wherein the funds used to purchase the item or service are taken from the funding source selected;
wherein the step of sending the funding source selection comprises selecting a funding source based on (i) data associated with the purchaser or (ii) data associated with a history of purchases by the purchaser at the merchant; and
wherein the list of funding source options associated with the purchaser are configured a priori by said purchaser using a message sent to said server device via SMS.

10. The method of claim 9, wherein the step of completing the transaction comprises:
sending, to the device associated with the merchant from the server device, a request to confirm the purchase;
receiving, at the server device from the device associated with the merchant, a response to the request to confirm the purchase; and
completing the purchase transaction if the response indicates that the purchaser has confirmed the purchase.

11. The method of claim 9, wherein
the information identifying the purchaser comprises a mobile telephone number of the purchaser.

12. The method of claim 9, wherein:
said step of sending the funding source selection comprises selecting a funding source based on data associated with the purchase; and
said data associated with said purchase is a total purchase price of said purchase.

13. The method of claim 9, wherein
said step of sending the funding source selection comprises selecting a funding source based on a history of purchases by the purchaser at the merchant.

14. A process comprising:
receiving a message sent via SMS from a purchaser, said message containing an a priori funding source selection for a payment service used to conduct a purchase transaction;
receiving, at a server device from a device associated with a merchant, a request to transfer funds to said merchant on behalf of said purchaser; and
completing said purchase transaction, wherein said funds transferred to said merchant on behalf of said purchaser are taken from a funding source selected by said a priori funding source selection;
wherein said a priori funding source selection is stored so as to apply to all future transactions conducted by said purchaser using said payment service until said payment service receives a second a priori funding source selection from said purchaser.

15. The process of claim 14, further comprising:
receiving, at said server device from said device associated with said merchant, information identifying said purchaser;
wherein said information identifying said purchaser comprises a mobile telephone number of said purchaser.

16. The process of claim 14, wherein
said a priori funding source selection includes a set of prioritized funding sources.

17. The process of claim 16, wherein
said step of completing said purchase transaction includes exhausting a first payment source in said set of prioritized funding sources and taking funds from a second payment source in said set of prioritized funding sources.

18. The process of claim 14, further comprising:
receiving, at a server device from said purchaser, a second message via SMS, said message containing a second a priori funding source selection for said payment service used to conduct said purchase transaction;
wherein said a priori funding source selection and said second a priori funding source selection are used by said server to formulate a set of prioritized funding sources.

19. The process of claim 18, wherein said step of completing said purchase transaction comprises:
comparing said set of prioritized funding sources to a second set of merchant preferred funding sources; and
conducting a transfer of funds from a most highly ranked agreed upon funding source in said set of prioritized funding sources;
wherein said most highly ranked agreed upon funding source:
appears in said set of prioritized funding sources; and
is ranked higher in said set of prioritized funding sources than any other funding source that appears in said second set of merchant preferred funding sources.

20. The process of claim 18, wherein:
said second a priori funding source selection consists of a same set of funding sources as said a priori funding source selection, but has a different prioritized order for said set of funding sources; and
said a priori funding source selection and said second a priori funding source selection are stored together in a database.
